(19) United States
(12) Patent Application Publication
(10) Pub. No.: US 2010/0187382 A1
(43) Pub. Date: Jul. 29, 2010

(54) Storage Apparatus For Wearable Weights And Method

(76) Inventor: Arnold James Cook, Pittsburgh, PA (US)

Correspondence Address: ARNOLD J. COOK, 413 N. PASADENA DR., PITTSBURGH, PA, 15215, US

(21) Appl. No.: 12/360,211

(22) Filed: Jan. 27, 2009

(51) Int. Cl. F16M 11/20

(52) U.S. Cl. 248/188.91

(57) ABSTRACT

A novel apparatus for storing weighted garments is disclosed wherein the weighted garment is slid down onto the inner support system of the weighted garment support system such that the weighted garment is supported and balanced above the ground. The apparatus includes an inner support system that supports the weighted garment from inside and below the weighted garment. The apparatus includes different inner support system designs to hold different types of weighted garments including: weighted vests, weighted shirts, weighted pants, wrist weights, ankle weights and wearable hand weights. The apparatus also includes a support base that can hold one or more inner support systems and the base can be stationary or mobile. An apparatus is also disclosed that supports the weighted garments from the side through a hole in the weighted garment. In addition a method for positioning the weighted garment on the weighted garment support system is disclosed along with a method for washing and drying the weighted garment while the weighted garment rests on the weighted garment support system.

### FIELD OF THE INVENTION

The present invention is related to exercise weights that are worn on a user's body, more specifically to a system of storing wearable weights when they are not on the user's body.

### CROSS REFERENCE TO RELATED APPLICATIONS

Not applicable

### FEDERALLY SPONSORED RESEARCH OR DEVELOPMENT

Not applicable

### SEQUENCE OR COMPUTER PROGRAM

Not applicable

### BACKGROUND OF THE INVENTION

Wearable weights are worn to improve a user's physical condition, to add resistance to movement, to strengthen the user's muscles and cardiovascular system as well as to add impact to strengthen the user's bones and joints. Much research is currently being done to determine the value of wearing weights for a wide range of different physical issues from treating Autism, Multiple Sclerosis, to improving bone density for osteoporosis sufferers, as well as improving weight loss and athletes' physical condition.

Individuals, families, sports teams, schools, gyms, hospitals, physical therapists, and trainers are now using weighted vests, weighted pants and other weighted clothing. A person or a group of people may wear weighted clothing for training from a few minutes to many hours a day. In most cases, the weighted clothing however remains unused most of the day.

The weighted clothing and often the additional weights used to add or remove weight from the clothing must be stored. Weighted clothing however cannot be stored like conventional un-weighted clothing because it is too heavy for conventional hangers, coat hooks, and closet rods. In addition, weighted clothing on standard clothing hanger can be difficult to lift and hang on a standard height closet rod or coat hook. As a result, weighted clothing is typically piled in an undesirable manner on the floor or over a chair when it is not in use.

Users of multiple pieces of weighted clothing have the most difficult situation. Sports teams, police cadet training facilities, military training facilities, and fitness facilities conduct training where multiple users use many pieces of weighted clothing at the same time. After training the users are often exhausted and simply drop the weighted clothing into a pile for others to deal with. This is a difficult situation for the facility and the people working there. After a training session, the facility workers have a pile of sweaty heavy clothing in an immovable pile on the floor that the workers then have to move, clean, and store. The facility workers then have to find a place to put the weighted clothing.

Standard clothing hangers do not work well for weighted clothing, especially weighted pants and weighted vests. Standard clothing hangers have a triangular shape with a hook at the top to hang the standard clothing hanger on a closet rod or coat hook. Standard clothing hangers are typically made of wire, plastic or wood. To position a piece of clothing on a standard clothing hanger a user holds the clothing in one hand and the standard clothing hanger in the other hand, then in the case of a jacket, shirt, or vest, the user slides the hanger in the neck hole first. The user positioning one shoulder and then the other shoulder of the garment on the standard hander moving both the standard clothing hanger and the garment. The garment is in the correct position when that the sides of the hanger hold the shoulders of the garment. Positioning pants on a standard hanger is also done by first holding the pants in one hand and the standard clothing hanger in the other hand. The standard clothing hanger typically has a horizontal rod over which the pants are then carefully hung such that the pants balance on the rod. The pants are slid into a balance position with one hand while the other holds the hanger.

The clothing that is hung on a standard hanger typically weighs very little. Shirts weigh less than a pound, pants weigh about a pound, and heavy winter coats may weigh a few pounds. Standard hangers are designed to just support only a few pounds of weight and are not designed to hold the 10 to 100 pounds of a weighted garment.

Increasing the strength of standard hangers to support the weight of weighted garments can solve only part of the problem, the weighted garments are very difficult to hang on standard hangers and the closet rods and coat hooks that standard hangers hook on to are also not designed to support the added weight of the weighted garments. Two hands are required to hold or move most weighted clothing making it often impossible to place the weighted garment on a hanger as done with a normal piece of clothing, clothing and one hand and the hanger in the other. The only way is to lay the weighted clothing on the ground and then position the standard clothing hanger in place. Once the standard hanger is in place the combination must then be lifted onto a closet rod or coat hook. Lifting the whole combination then high enough with tile extra weight and keeping the hanger in position inside while the weighted garment is lifted, is also awkward and requires a lot of strength.

Even if heavy-duty standard hangers are found or made there is still the problem that closet rods and coat hooks are not designed to support the weights of weighted clothing. In addition closet rods and coat hooks are typically positioned height enough for long dress and coats. So that even if the closet rod or coat hook is strong enough to support the weight of the weighted clothing the user must lift the weighted clothing high enough to position it on the closet rod or coat hook. For many that use weighted vests such as the elderly and those that use very heavy vests, this high a lift of the weighted garment can be difficult, dangerous and often impossible without help.

What is needed is a system for storing single as well as multiple pieces of weighted clothing that is safe, simple to use, and allows weighted garments to be cleaned and dried.

### SUMMARY OF THE INVENTION

The present invention relates to weighted garments and more specifically an apparatus and method for storing weighted garments and a method for cleaning weighted garments.

Weighted garments being articles of clothing worn by a user that contain weights for the purpose of adding resistance to the movements of the user's body when the weighted garments are worn on the user. Weighted garments include, but are not limited to, the following: weighted shirt, weighted vests, weighted head gear, weighted pants, weighted socks, weights gloves or wearable hand weights, wrist weights, ankle weights, foot weights and shoe weights. Weighted vests are quickly becoming the most widely used type of weighted garment.

The present invention is an apparatus for storing and cleaning of weighted garments that includes a weighted garment support system with an inner support system that extends up from the floor and is held in place by a support base. The inner support system includes a top support that extends horizontally and is used to support the weighted garment. The weighted garment slides on to, rests on, and is balanced on the inner support system. To position the weighted garment on the apparatus of the present invention the users slides the weighted garment down or sideways onto the inner support system such that the weighted garment rests on the top support system of the inner support system. The weighted garment rest on and is balanced on the inner support system. The present invention also includes right and left side supports that guide the weighted garment into position on the weighted garment support system and help to keep the weighted garment in position on the weighted garment support system.

The present invention includes a support base that can support one or more inner support systems and can sit on the ground or be rolled to different locations. The present invention also includes the design of different inner support systems to hold different weighted garments.

The present invention includes a method for positioning the weighted garment on the weighted garment support system wherein the weighted garment is slid down on to the inner support system or slid form one side onto the inner support system.

The present invention also includes the method of cleaning and drying one or more weighted garments wherein the weighted garments are positioned on the weighted garment support system, then the weighted garments are washed and rinsed, and then the weighted garments are then left on the weighted garment support system to dry.

### BRIEF DESCRIPTION OF THE DRAWINGS

In the accompanying drawings, the preferred embodiment of the invention and the preferred methods of practicing the invention are illustrated in which:

FIG. 1 is a schematic representation of the weighted garment support system of the present invention with a weighted garment positioned on the inner support system.

FIG. 2A, FIG. 2B and FIG. 2C are schematic representations of the weighted garment support system of the present invention illustrating the method of sliding a weighted garment on to the inner support system.

FIG. 3 is a schematic representation of a user lowering a weighted garment on to the weighted garment support system of the present invention.

FIG. 4 is a schematic representation of the inner support system being connected to the support base of the present invention.

FIG. 5A, FIG. 5B and FIG. 5C are schematic representations of the weighted garment support system of the present invention with one, two and three inner support system connected to a support base.

FIG. 6 is a schematic representation of the weighted garment support system with three inner support system connected to one support base with three weighted garments positioned on the inner support systems.

FIG. 7 is a schematic representation of the weighted garment support system of the present invention wherein two inner support systems are connected to one support base, the first inner support system with a neck alignment area and the second inner support system with a solid inner core.

FIG. 8 is schematic representation of an alternative embodiment of the weighted garment support system of the present invention wherein the inner support system has only one side support and the base is welded to the support base.

FIG. 9 is schematic representation of the alternative embodiment of the weighted garment support system of the present invention wherein the weighted garment is a weighted vest and the inner support system exits through one arm hole in the weighted garment and then down to the support base.

FIGS. 10A and 10B are schematic representations of the weighted garment support system of the present invention illustrating a weight vest without sleeves being slid from the slide through one arm hole on to the weighted garment support system.

FIG. 11 is a schematic representation of the weighted garment support system of the present invention wherein the support base includes wheels, multiple inner support systems, and a support shelf.

FIGS. 12A and 12B are schematic representations of the weighted garment support system of the present invention with wheels and multiple inner support system wherein a weighted garment is being lowered on to an inner support system and multiple weighted garments are illustrated on the weighted garment support system.

FIG. 13 is schematic representation of the weighted garment support system of the present invention wherein different inner support system designs are illustrated supporting different types of weighted garments including a weighted vest, a pair of weighted pants, a pair of wearable hand weights, and a pair of ankle weights.

### DETAILED DESCRIPTION

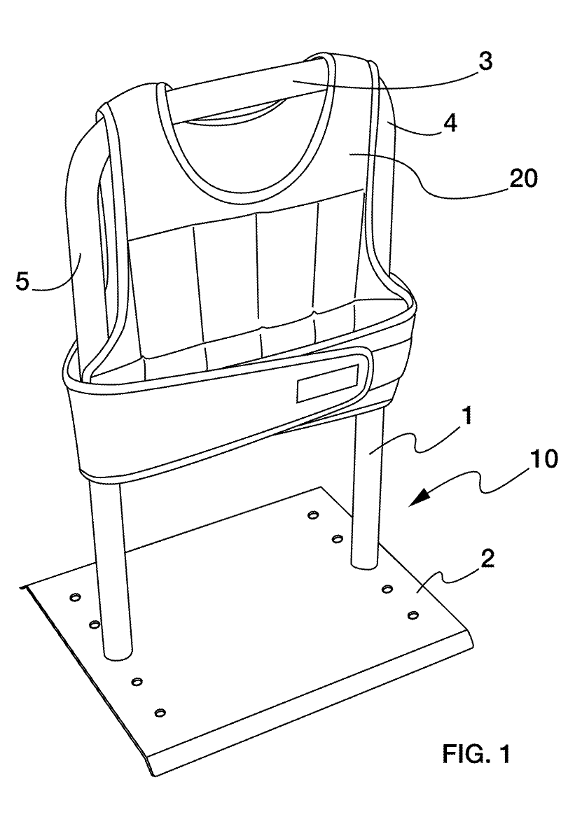

Referring now to the drawings wherein like reference numerals refer to similar or identical parts throughout the several views, and more specifically to FIG. 1 through FIG. 13, there is shown a weighted garment support system 10. The weighted garment support system 10 consists of an inner support system 1 and a support base system 2 that holds the inner support system 1 in position.

The present invention includes an apparatus for storing weighted clothing that is worn on a user's body, referred to as weighted garment(s) 20 herein. The user's weighted garment 20 must be stored whenever the weighted garment 20 is not being used. The present invention includes a method for positioning the weighted garment 20 on the apparatus of the present invention for storage, and a method for cleaning and drying the weighted garment 20 held in position by the apparatus of the present invention.

FIG. 1 illustrates the weighted garment support system 10 of the present invention wherein a weighted garment 20 is a weighted vest and is supported above the ground by the inner support system 1. The inner support system 1 supports the weighted garment 20 above the ground in the same orientation as the weighted garment 20 is worn on the user's body. In the preferred embodiment of the present invention, the inner support system 1 includes a top support 3 and a left side support 4 and a right side support 5. A weighted garment 20 positioned on the weighted garment support system 10 is supported on the top by the top support 3 and on the sides by the right side support 5 and the left side support 4. The top support 3 supports all the weight of the weighted garment 20 and can be used without the right side support 5 or the left support 4. Preferably the weighted garment support system 10 includes left side support 4 and right side support 5 which hold the sides of the weighted garment 20 and help to maintain the weighted garment 20 in position on the weighted garment support system 10. The right side support 5 and the left side support 4 keep the weighted garment from sliding to the left or right and prevent the weighted garment 20 from coming off the top support 3.

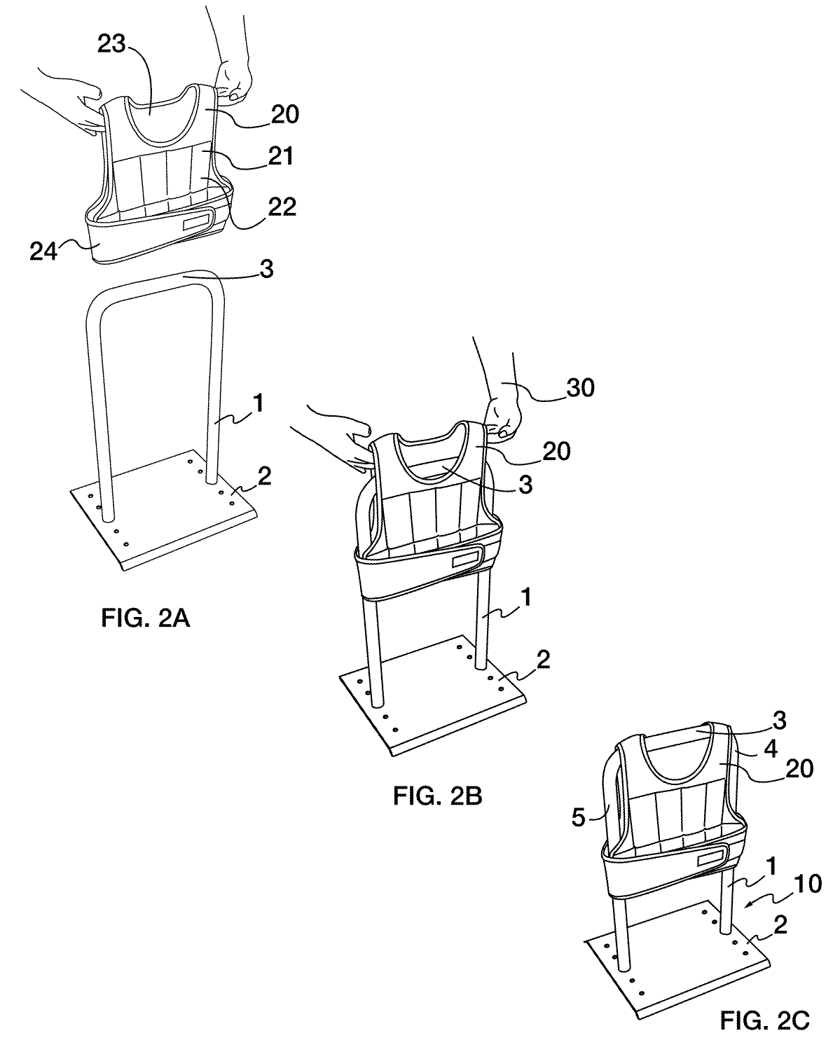

In the preferred embodiment illustrated in FIG. 1 the inner support system 1 is fabricated out of tubing which can range from less than one inch diameter to greater than four inches in outside diameter, more preferably the tubing is between one and two inches in diameter. The weighted garment support system 10, inner support system 1, extends directly down to the ground and is held in an upright position by the support base 2. In the preferred embodiment of the present invention illustrated in FIG. 1 all the support that is used to hold up the weighted garment 20 is directly below the weighted garment 20, no support extends above the weighted garment 20. The weighted garment 20 is positioned on the weighed garment support system 10 by holding the weighted garment 20 above the inner support system 1 by the top of the weighted garment 20 by the user 30 as illustrated by FIG. 2A, then user 30 then lowers the weighted garment 20 onto the inner support system 1 such that the weighted garment 20 slides down onto the inner support system 1. The inner support system 1 fits inside the weighted garment 20. FIG. 2B illustrates the weighted garment 20 sliding onto the inner support system 1 through the waist section of the weighted garment 20. FIG. 2C illustrates the weighted garment 20 then positioned on and balanced on the top support 3 of the inner support system 1.

In the preferred embodiment illustrated in FIG. 2A, FIG. 2B and FIG. 2C the weighted garment 20 has a weighted vest front 22 and weighted vest back 23 as well as weighed vest belts 24 which connect the weighted vest front 22 and weighted vest back 23 together on the sides of the weighted vest 20. When the weighted garment 20 is slide down onto the inner support system 1, the inner support system 1 slides between the weighted vest front 22 and weighted vest back 23. Once the weighted garment 20 is slid completely on to the inner support system 1, the shoulders of the weighted vest 20 that connect the weighted vest front 22 to the weighted vest back 23 rest on the top of the weighted garment 20, are balance on and supported by the top support 3. FIG. 2C illustrates the weighted garment 20 that has been slid onto the inner support system 1 and is being held up by the top support 3.

Preferably, the sides of the weighted garment 20 are supported by the left side support 4 and right side support 5. When the weighted garment 20 is slid onto the inner support system 1, the left side support 4 and right side support 5 helps to guide and orientate the weighted garment 20 in position on the inner support system. Once the weighted garment 20 rests on the top support 3, preferably the right side support 5 and left side support 4 keep the weighted garment 20 in position on the inner support system 1. The present invention allows the user 30 to use both of the user's 30 hands to lift, slide, and position the weighted garment 20 on the inner support system 1. The weighted garment 20 may weigh less than 10 pounds or over 100 pounds. Holding all of the weight of the weighted garment 20 above the ground normally requires both of the user's 30 hands and arms. Also lifting a weighted garment 20 becomes increasing more difficult the higher the weight of the weighted garment 20. The present invention minimizes the height the weighted garment 20 must be lifted above the ground by the user 30 and allows the user 30 to lift the weighted garment 20 close to the user's 30 body, and allows the user 30 to use both hands to support the weight of the weighted garment 20. Preferably, the weighted garment support system 10 only requires the user 30 to lift the weighted garment 20 to about the user's 30 waist level above the ground. Preferably, the top support 3 is positioned just high enough to keep the weighted garment 20 from resting on the ground. In the preferred embodiment the top of the inner support system 1, top support 3 is between 13 and 48 inches above the ground, more preferably, between 15 and 26 inches above the ground for most adult sized weighted garment 20. Lower heights below 15 inches may be employed for a weighted garment support system 10 for children.

The present invention solves the problems that occur when trying to put a weighted garment 20 on a standard clothing hanger and when trying to hang the weighted garment 20 on a standard clothing hanger onto a closet rod or coat hook. The present invention supports the weighted garment 20 from directly below and from the inside the weighted garment 20. Standard hangers support a garment from above with a hook that extends out of the neck opening of the garment. Standard clothing hangers require that the garment be positioned inside the garment first with a connector such as a hook extending out of the neck opening of the garment, then the garment on the hanger must be lifted tip and hooked onto a rod or hook.

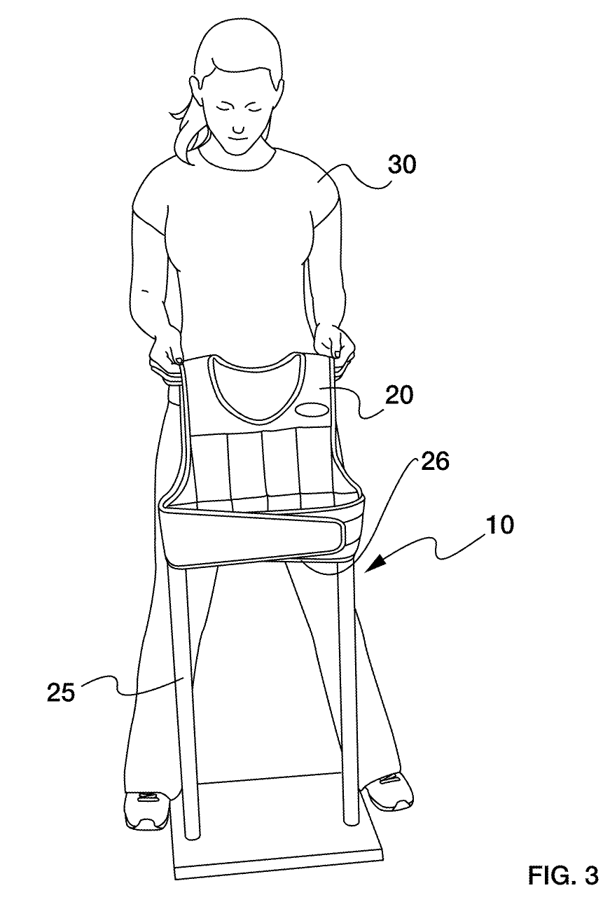

The present invention makes hanging up weighted clothing a simple one step process requiring minimal lifting. The weighted garment support system 10 needs only to be as high as the height of the weighted garment 20 to keep the weighted garment 20 off the ground. FIG. 3 illustrates the user 30 lowering a weighted garment 20 onto the weighted garment support system 10. The user 30 can stand very close to the inner support system 1 with the weighted garment 20 close to the user's 30 body. The user 30 has the greatest amount of strength close to the user's 30 body and the user's 30 center of gravity. With the present invention the user 30 can use both of the user's 30 hands to hold the weight of the weighted garment 20. Weighted garments 20, such as a weighted vest, may range from less than 5 pounds to over 100 pounds, and both arms of the user 30 are often required to lift or move the weight of the weighted garment 20. The user 30 also needs two hands on the garment to position the weighted garment 20 over the inner support system 10 so that the weighted garment 20 can be slid onto the inner support system 1. The user's 30 two hands are needed to align the weighted garment 20 over the weighted garment support system 10. Using one hand to hold the weighted garment 20 could allow the weighted garment 20 to bend and twist, and the opening at the waist area of the weighted garment 20 would be difficult to align with the inner support system 1.

In the preferred embodiment of the inner support system 1, the inner support system 1 includes a radius 25 or angle at the top of the inner support system 1 to help align the top of the inner support system 1 and the waist opening 26 at the bottom of the weighted garment 20. As the weighted garment 20 is slid onto the inner support system 1 the radius 25 pushes on the sides of the weighted garment 20 and spreads out the weighted garment 20 so that the sides of the weighted garment 20 are held out by the right side support 5 and the left side support 4. When the top of the weighted garment 20 is positioned on the top support 3 the weighted garment is supported above the ground. The top support 3 holds the weight of the weighted garment 20 while the left side support 4 and right side support 5 hold the sides of the weighted garment 20.

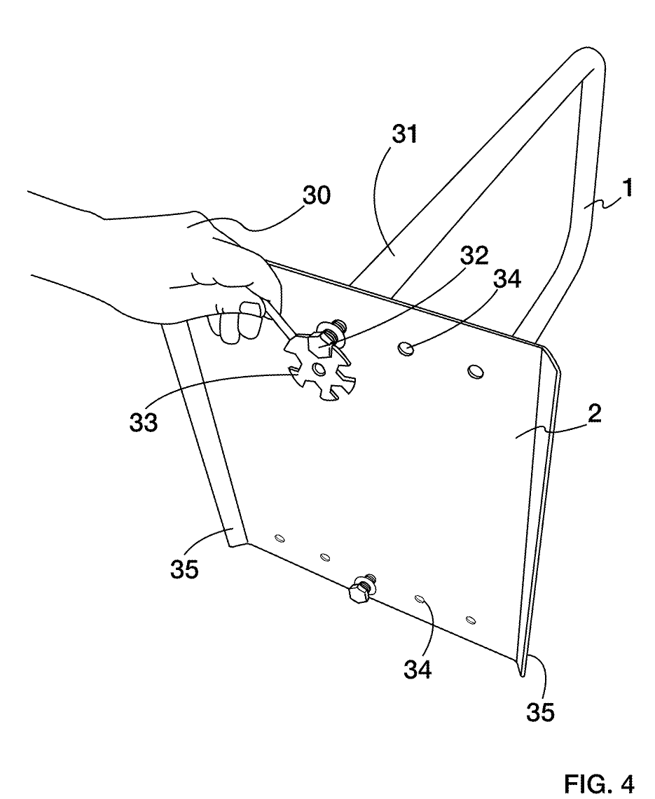

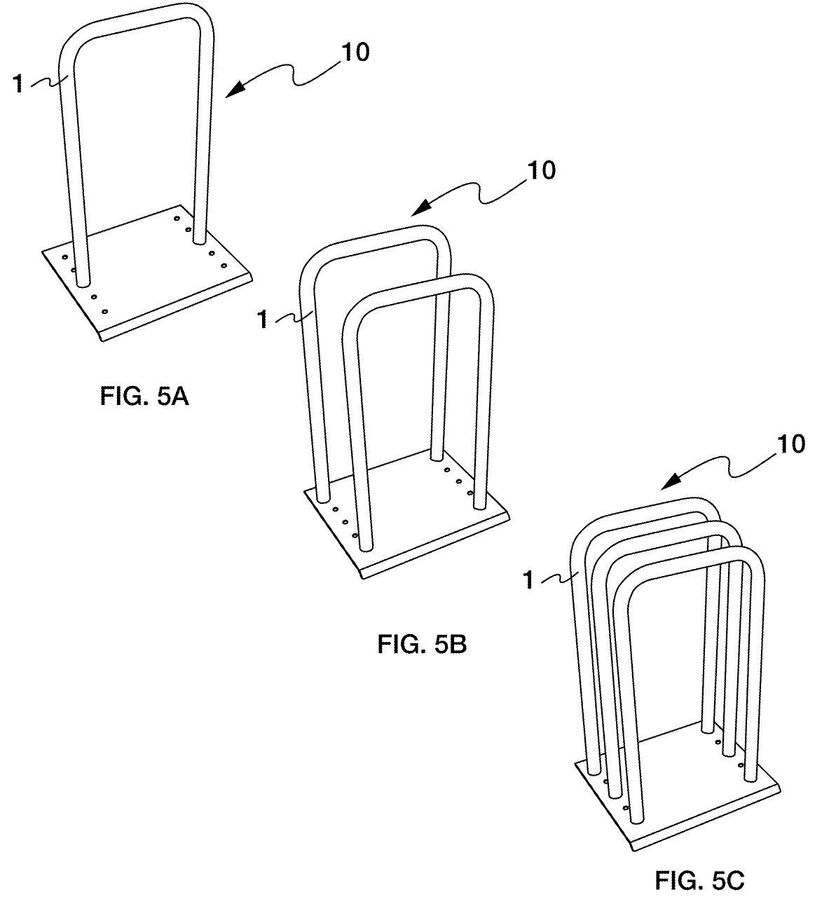

The inner support system 1 may be supported in a vertical position in many ways preferably the support base 2 and inner support system 1 are welded or bolted together. FIG. 4 illustrates the preferred embodiment of the present invention wherein the inner support system 1 contains a threaded connection 31 at the bottom of the inner support system 1. Securing bolts 32 slide through the support base position holes 34 and are tightened with a tightener 33 to secure the inner support system 1 to the support base 2. The support base 2 must be strong enough to support the weight of the weighted garment 20 and prevent the inner support system 1 from falling over. In the preferred embodiment a metal plate is used, however plastic, wood, or combinations of materials may be used for either the inner support system 1 or the support base 2. In the preferred embodiment shown in FIG. 4, a ⅛ inch thick steel plate is used. Preferably, the support base 2 includes some type of feet to support the support base 2 on uneven surfaces. In the preferred embodiment illustrated in FIG. 4, the support base 2 has been bent on two sides to create support feet 35, such that the support base 2 rests on the ground on the support feet 35. Many other types of support feet or wheels may be used to position the support base 2 securely on the ground. In the preferred embodiment illustrated in FIG. 4, there are a number of support base position holes 34 to provide different bolting locations or the ability to have multiple inner support systems 1 on one support base 2. FIG. 5A, FIG. 5B, and FIG. 5C illustrate the support base 2 with one, two, and three inner support systems 1 connected to the support base 2. FIG. 5A illustrates one inner support system 1 bolted to the support base 2. FIG. 5B illustrates two inner support systems 1 bolted to the support base 2. FIG. 5C illustrates three inner support systems 1 bolted to the support base 2.

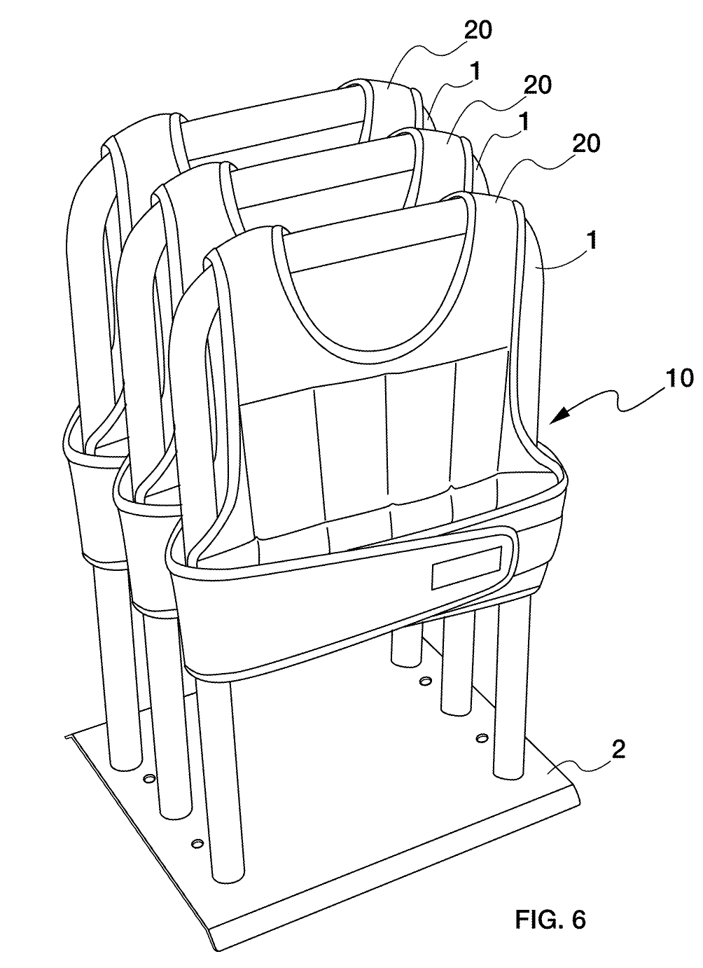

A number of the same type or different types of weighted garments 20 can be stored on one weighted garment support system 10. FIG. 6 illustrates the present invention wherein three weighted garments 20 are stored on three inner support systems 1 bolted to one support base 2. The support base 2 may be sized to fit any number of inner support systems 1, preferably, the inner support systems 1 are spaced far enough apart to allow each weighted garment 20 to slide onto the inner support system 1 without interference from the weighted garment 20 on the next inner support system 1.

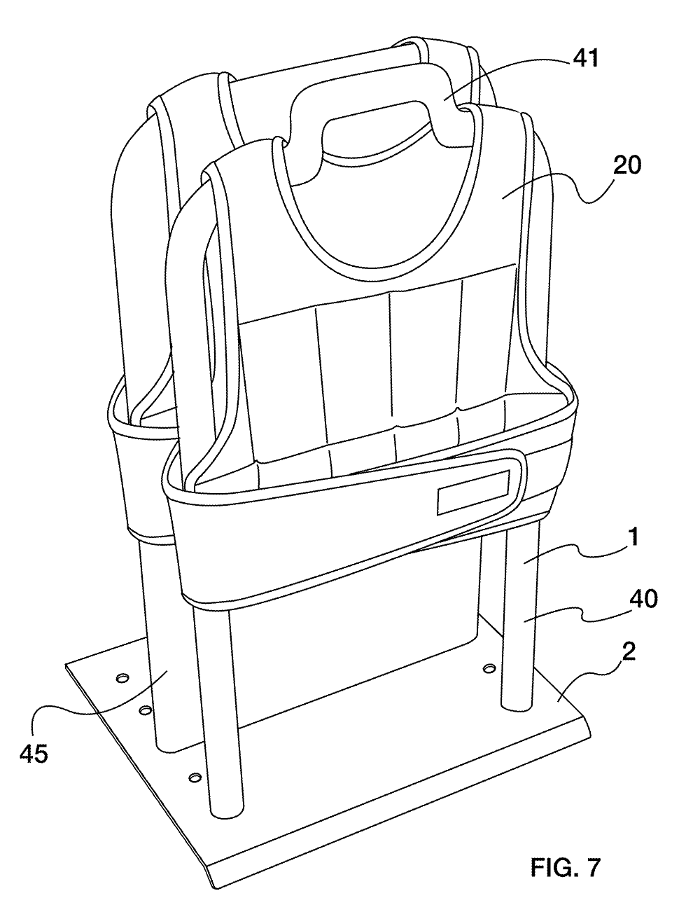

Different designs of the inner support system 1 may be created to support different weighted garment 20 designs. FIG. 7 illustrates two different designs of the inner support system 1 of the present invention. The first alternative inner support system 1 design, the neck alignment inner support 40 includes a raised neck area 41 that extends through the neck opening in the weighted garment 20. The raised neck area 41 helps align the weighted garment 20 on the neck alignment inner support 40. When the weighted garment 20 is put in place, the raised neck area 41 also prevents the weighted garment 20 from sliding sideways. The second alternative inner support system 1 design, the solid inner support 45 has no opening on the inside. A heater and/or air flow system can be for example designed into the inside of the solid inner support 45 to provide heat and air flow to dry the weighted garment 20 after it is washed. Alternatively the solid area sides of the solid inner support 45 can be used to support signage.

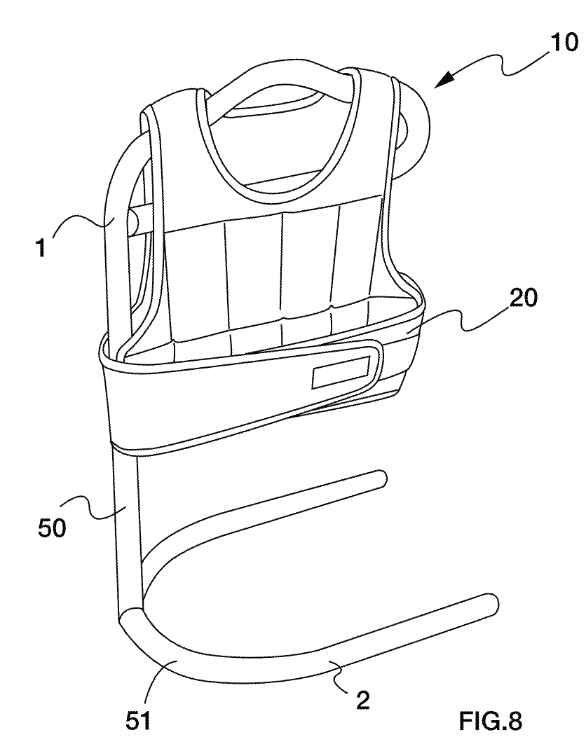

Preferably the inner support system 1 is made of steel pipe or tubing, however the inner support system 1 can be constructed of any material strong enough to support the weight of the weighted garment 20. The inner support system 1 may be supported from the support base 2 from two sides as shown in FIG. 1 through FIG. 7. Alternatively, the inner support system 1 may be supported from one support as illustrated in FIG. 8 wherein the inner support system 1 includes a single support leg 50 on one side of the inside the weighted garment 20. The support leg 50 may however be placed in different locations from center to off center of the weighted garment 20 being supported. Alternatively, different support base 2 designs may be used to support the inner support system 1, FIG. 8 support base 2 includes a bent tube base 51 which is welded to the support leg 50. The inner support system 1 may however be supported by one or more support legs 50 and the support base 2 may be designed with one or more contact locations on the ground to keep the weighted garment support system 10 stable.

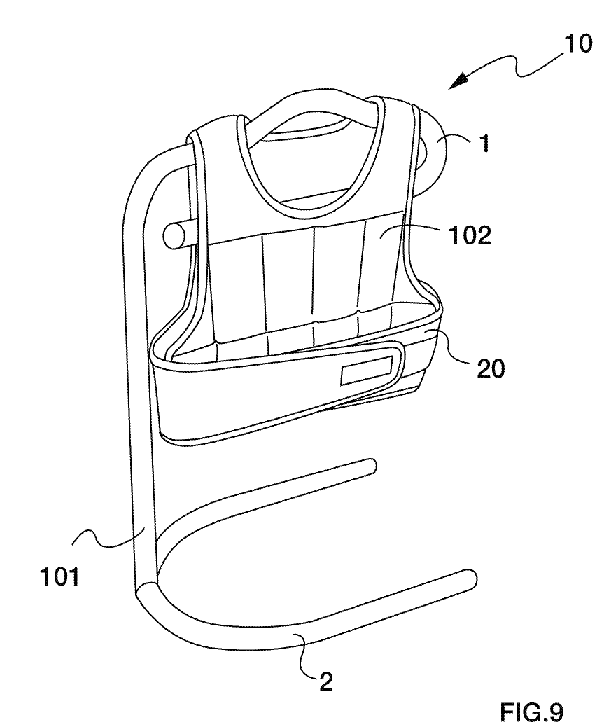

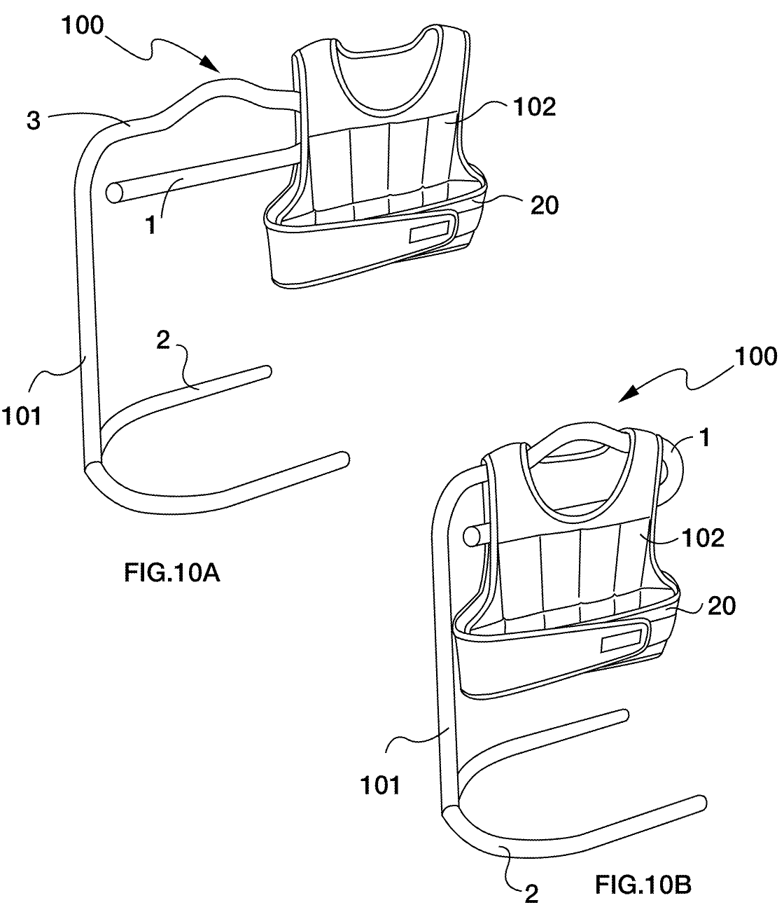

FIG. 1 through FIG. 8 have illustrated a weighted garment support system 10 wherein the weighted garment 20 is slid down from above onto the inner support system 1. Alternatively, the weighted garment 20 may be slid onto the inner support system 1 from the side. If the weighted garment 20 has no sleeves for example, such is the case of a weighted vest 102 illustrated in FIG. 9, the weighted vest 102, can be slid onto the inner support system 1 from one side as illustrated in FIG. 9. As illustrated in FIG. 9 the inner support system 1 being supported by side support 101 through one arm hole on the side of the weighted vest 102. The side support 101 connects to the support base 2 by running down on the outside of the weighted vest 102. FIG. 10A and FIG. 10B illustrate the alternative embodiment of the current invention wherein the weighted garment 20 is a weighted vest 102 and the weighted vest 102 is slid sideways onto the inner support system 1 through one arm hole in the weighted vest 102. FIG. 10A illustrates the weighted vest 102 being slid sideways onto the side supported weighted garment support system 100. The weighted vest 102 is slid onto the inner support system 1 through one arm hole in the weighted vest 102 and then the weighted vest 102 is positioned on the top support 3. FIG. 10B illustrates the weighted vest 102 resting on the top support 3 of the inner support system 1 with the inner support system 1 supported through the arm of the weighted vest 102 and supported by the side support 101 outside the weighted vest 102. The side support 101 may be connected to a wall or preferably as shown in FIG. 10A and FIG. 10B the side support 101 is connected to the support base 2.

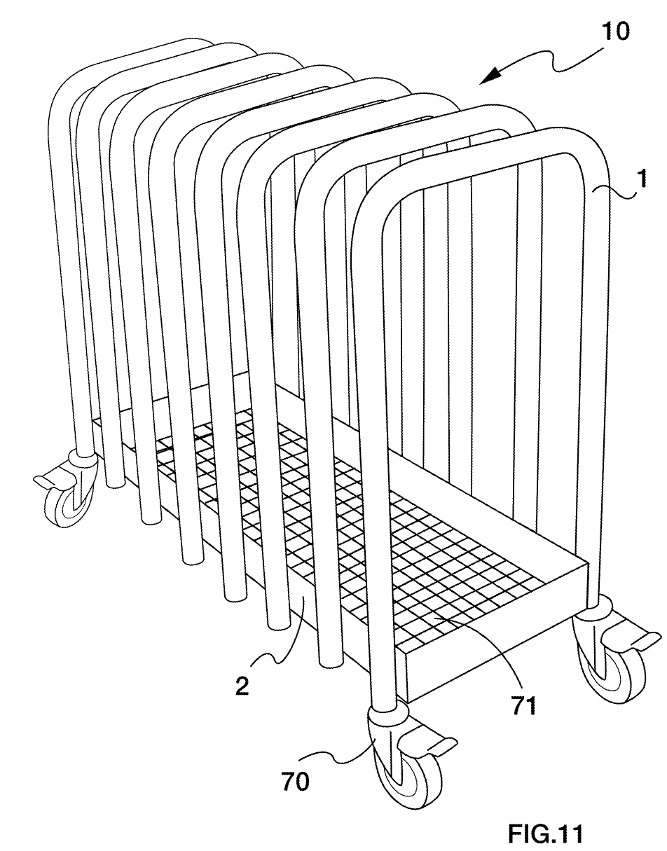

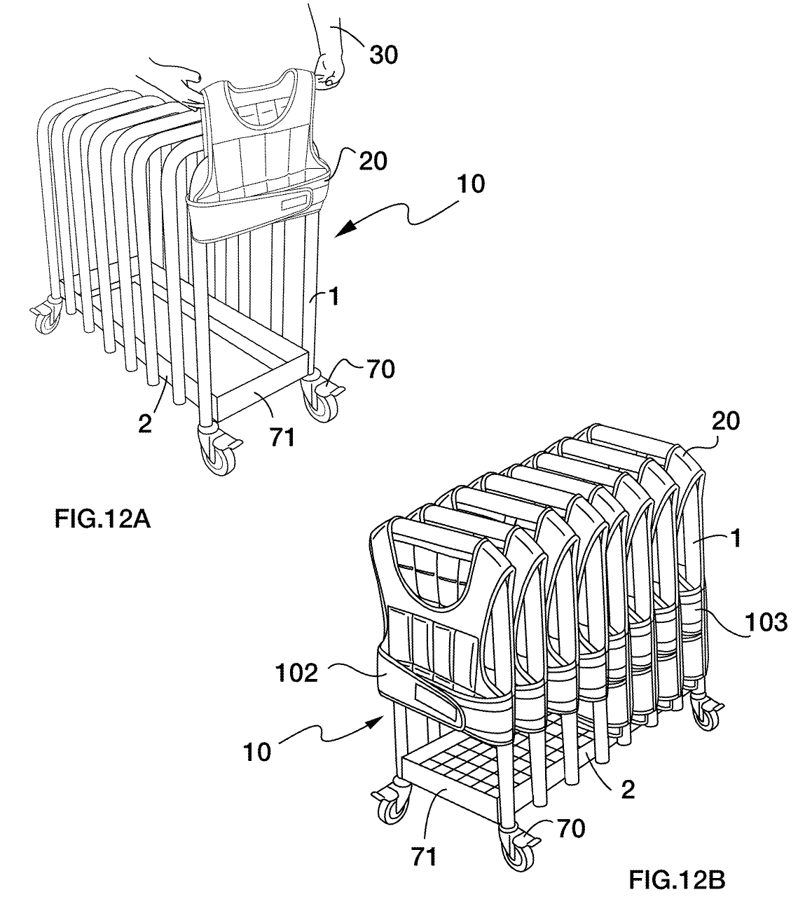

The support base 2 may be stationary or may have wheels and may be mobile. FIG. 11 illustrates an alternative embodiment of the present invention wherein the support base 2 includes wheels 70 such that weighted garment support system 10 can be moved around easily. In this preferred embodiment, multiple inner support systems 1 are connected to the support base 2. Preferably, there is also a support shelf 71 on the support base 2 that can hold additional weights and/or other gear such as hand weights, ankle, or shoe weights. FIG. 12A and FIG. 12B illustrate an alternative embodiment with the support shelf 71 removed and with weighted garments 20 being positioned or positioned on the inner support system 1. FIG. 12A illustrates a weighted garment 20 being lowered onto an inner support system 1 by user 30. FIG. 12B illustrates the weighted garment support system 10 loaded with eight weighted garments 20, the weighted garments 20 being four short weighted vests 102 and four long weighted vests 103.

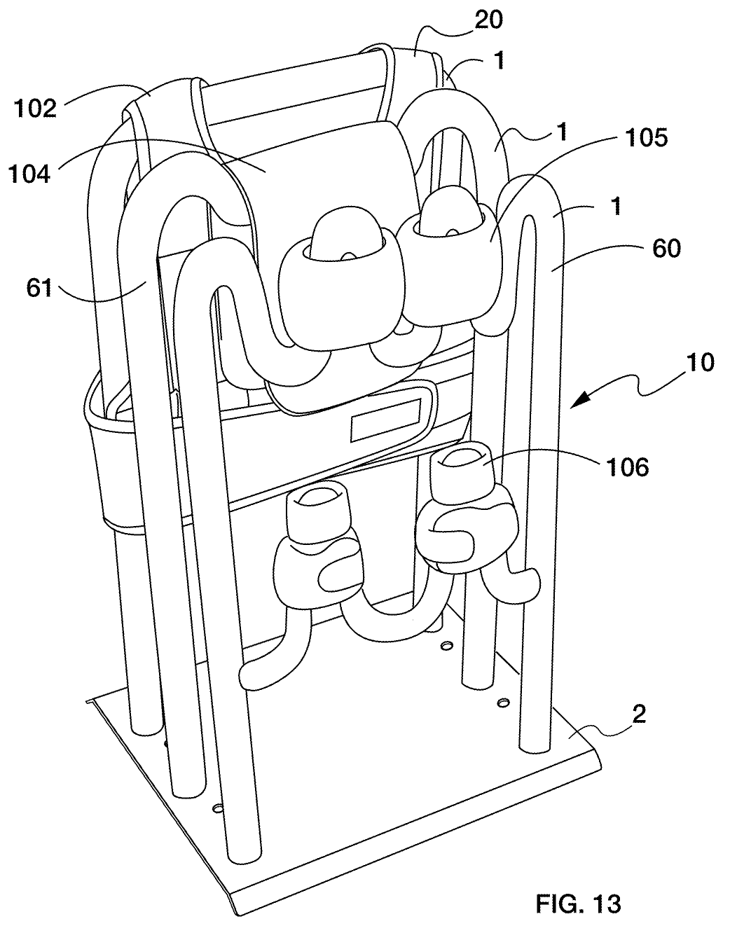

Many different types of weighted garments 20 may be supported by the weighted garment support system 10 of the present invention. A weighted garment 20 includes any garment worn on the user's 30 body that can be weighted for example: weighted shirts, weighted jackets, weighted vests, weighted pants, weighted head gear, weighted gloves, wearable wrist weights, wearable foot weights, weighted socks, and wearable ankle weights. Different inner support system 1 designs make it possible to hold different types of weighted garments 20. FIG. 13 illustrates a weighted garment support system 10 with three different inner support system 1 designs used to hold different types of weighted garments 20 on the same support base 2. FIG. 13 illustrates and set of wearable hands 106 and a pair of wearable ankle weights 105 slid onto a support rack 60. The support rack 60 includes multiple posts close to the size of the user's 30 appendage that the wearable weighted garment 20 fits on. In addition, FIG. 13 illustrates a pair of weighted pants 104 slid over and balanced on a pants support rack 61.

In addition to the apparatus disclosed above the present invention includes a method of placing and removing a weighted garment 20 from the weighted garment support system 10 wherein first the weighted garment 20 is stored by holding the weighted garment 20 above the inner support system 1, and then the weighted garment 20 is slid down, or slid from one side, and positioned on the inner support system 1 such that the weighted garment 20 is balanced on the inner support system 1. Then when the user 30 is ready to wear the weighted garment the user 30 slides the weighted garment 20 upward or to the side to remove the weighted garment 20 from the weighted garment support system 10.

In addition the present invention includes a method of cleaning and drying weighted garment 20 wherein weighted garment 20 is first positioned on the weighted garment supports system 10 and then the weighted garment 20 is washed and rinsed while on the weighted garment support system 10, then the weighted garments is dried while still on the weighted garment support system 10. The weighted garment support system 10 offers many advantages for cleaning multiple weighted garments 20. One or more weighted garment 20 can be hard to move around and wash. By using the present invention with wheels connected to the support base 2 the weighted garment(s) 20 can be easily rolled into a shower or outside, where the weighted garment(s) 20 can be easily washed with soap and water and then rinsed. The weighted garment(s) 20 can then be positioned in the sun to dry or placed in another warm location to dry. The inner support system 1 designs that is open on the inside allow air to flow to the inside of the weighted garment(s) 20 and the air flow helps the weighted garment(s) 20 to dry faster.

The present invention includes an apparatus for supporting one or more weighted garments comprising: an inner support system which supports a weighted garment from the inside above the ground; one or more support braces which hold the inner support system from below the weighted garment; and a support base which sits on the ground and which holds the support braces.

The present invention includes an apparatus wherein the support brace exits the Inside of the weighted garment through a bottom hole in the garment.

The present invention includes an apparatus wherein the inner support system and the support brace are connected together.

The present invention includes an apparatus wherein the support base supports more than one inner support systems.

The present invention includes an apparatus wherein the inner support system is fabricated of metal or plastic tubing that is hollow or solid.

The present invention includes an apparatus wherein the support base includes wheels or other devices that would make the apparatus mobile.

The present invention includes an apparatus for supporting one or more weighted garments comprising: an inner support system which supports the weighted garment from inside the garment; one or more braces which hold the inner support system from one side of the weighted garment; and a side support which maintains the position of the braces above the ground.

The present invention includes an apparatus wherein the support braces exits the inside of the weighted garment through an opening in the weighted garment.

The present invention includes an apparatus as described in claim 7 wherein the side support is connected to a base that is positioned on the ground.

The present invention includes an apparatus wherein the side support is connected to a wall or vertical surface.

The present invention includes an apparatus wherein more than one inner support system is connected to one side support.

The present invention includes a method of positioning and storing weighted garments when the weighted garments are not being worn on a users comprising: first the weighted garment is held above an inner support system; then the weighted garment is lowered on to the inner support such that weight is supported by the inner support system with half the weight of the garment on one side of the inner support and the other half of the weight on the other side of the inner support.

The present invention includes a method wherein once the weighted garment is positioned on the inner support system, the garment is washed and dried while resting on the inner support system.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. An apparatus for supporting one or more weighted garments comprising:
an inner support system which supports a weighted garment from the inside above the ground;
one or more support braces which hold the inner support system from below the weighted garment; and
a support base which sits on the ground and which holds the support braces.

2. An apparatus as described in claim 1 wherein the support brace exits the inside of the weighted garment through the a hole in the weighted garment.

3. An apparatus as described in claim 1 wherein the inner support system and the support brace are connected together.

4. An apparatus as described in claim 1 wherein the support base supports more than one inner support systems.

5. An apparatus as described in claim 1 wherein the inner support system is fabricated of metal or plastic tubing that is hollow or solid.

6. An apparatus as described in claim 1 wherein the support base includes a moving device to allow the weighted garment support system to move with the weighted garments on the weighted garment support system.

7. An apparatus as described in claim 1 wherein the support base includes a moving device including wheels to allow the weighted garment support system to move with the weighted garments on the weighted garment support system.

8. An apparatus for supporting one or more weighted garments comprising:
an inner support system which supports the weighted garment from inside the garment;
one or more braces which hold the inner support system from one side of the weighted garment; and
a side support which maintains the position of the braces above the ground.

9. An apparatus as described in claim 8 wherein the support braces exits the inside of the weighted garment through an opening in the weighted garment.

10. An apparatus as described in claim 8 wherein the side support is connected to a base that is positioned on the ground.

11. An apparatus as described in claim 8 wherein the side support is connected to a vertical surface.

12. An apparatus as described in claim 8 wherein the side support is connected to a wall.

13. An apparatus as described in claim 8 wherein more than one inner support system is connected to one side support.

14. A method of positioning and storing weighted garments when the weighted garments are not being worn on a users comprising:
first the weighted garment is held above an inner support system; then
the weighted garment is lowered on to the inner support such that weight is supported by the inner support system with half the weight of the garment on one side of the inner support and the other half of the weight on the other side of the inner support.

15. A method as described in claim 14 wherein once the weighted garment is positioned on the inner support system the garment is washed and dried while resting on the inner support system.
